(19) United States
(12) Patent Application Publication
(10) Pub. No.: US 2002/0164972 A1
(43) Pub. Date: Nov. 7, 2002

(54) Device for protecting aftermarket car stereos, both detachable and fixed panel, from various environmental pollutants, conditions, and theft while installed in a vehicle

(76) Inventor: Frederick Ryan White, Medford, OR (US)

Correspondence Address: FREDERICK R. WHITE, 1541 VALLEY VIEW DR, MEDORD, OR, 97504, US

(21) Appl. No.: 09/681,579

(22) Filed: May 2, 2001

(51) Int. Cl. H04B 1/06

(52) U.S. Cl. 455/344; 455/345; 455/348; 455/349

(57) ABSTRACT

This purpose of this device is to protect an after market car stereo, of DIN size, installed in a vehicle from environmental pollutants, conditions, and theft. The device has tapering sides, which will allow it to fit onto after market car stereos installed in cars where there is minimal distance between the after market stereo and the dash of the car. The composition of the device is a multiple thickness plastic. This is what allows the device, when applied in a vehicle with an after market car stereo installed, to give the car a look of having no stereo installed. There is medium density foam located in the inside of the back plate, which acts as both an insulator and a filter against environmental pollutants and conditions.

### CROSS REFERENCE TO RELATED APPLICATIONS

D414772 October, 1999 Adelaar D14/217 D430555 September, 2000 Adelaar D14/217 5979836 November, 1999 Kim 248/27.3 5109420 April, 1992 Nonaka 381/86 4562595 December, 1985 Bauer et al. D14/258 5004634 April, 1991 Anthony D14/258 4248069 February, 1981 Burbank 455/345. 4365280 December, 1982 Crosetti et al. 428/919 4532162 July, 1985 Neece 428/31. 4584717 April, 1986 Strickland 428/919. 4918750 April., 1990 Buckley 455/345 D357025 April, 1995 Tokiyama et al. D14/258

### BACKGROUND OF INVENTION

The concept of anti-theft in car audio took a major turn with the development of the detachable face for after market car stereos. This concept was to give an after market car stereo without a face no value to a potential thief. The first problem that presented itself is that the detachable faces became available to thieves, which made it more desirable to steal an after market stereo. Prior art attempted to solve this problem of theft by covering up the body of the after market car stereo exposed on the dash, or the visible part left after detaching the face, by sliding over the exterior and attaching itself to the after market car stereo with a protruding piece that slides into the loading mechanism of the after market car stereo. Patent D430555 and patent D414772 demonstrate this attempt with the first being for cassette and the second compact disc. These demonstrate numerous problems when attempting to do what they are designed to do. First, being that the protruding piece of the design slides into the loading mechanism of the unit, which, especially if the after market car stereo contains an automatic loading mechanism, will cause the unit's loading mechanism to become defective. This particular feature also prevents these prior arts from being able to be applied to after market car stereo that have a fixed, fold down face. Second, the devices themselves are limited, by design, to which after market stereos they can be applied too simply due to the numerous types of vehicles in production and how differently an after market car stereo is installed in each. Third, these particular prior arts don't claim to give, once applied, a car with an after market car stereo installed a factory look of having no stereo in it. Fourth, there is no protection given to the exposed after market car stereo parts once the prior art is applied. My new device solves each of these described problems completely. First, by having exact dimensions, which allow it to fit onto all after market car stereos with a cosmetic trim ring, and those not having a cosmetic trim ring, but having the same dimensions as one with. This feature also allows this device to be applied to both after market car stereos having a detachable face and those having a fixed, fold down face. With tapering sides this new device allows it to be applied to any after market car stereo installed in any car with limited distance between the after market car stereo and the vehicle's dash or installation kit, which solves the second described problem of prior art. By using the composition of plastic this new device will give, once applied, a look of a car with no stereo installed in it from the factory, which isn't addressed in prior art. This new device with its applied medium density foam on the inside of the back plate will give protection to the exposed after market car stereo after its face from various environmental pollutants and conditions, which isn't present in any prior art. Overall, this new device will add longevity to an after market car stereo by cutting down on theft, and protecting it from all the conditions the environment demonstrates from day to day.

### SUMMARY OF INVENTION

This device solves the problems of prior art by providing a universal application for all types of after market car stereos, of DIN size, as well as adding protection from environmental pollutants, conditions, and theft. The purpose of this device is to protect an after market car stereo from various environmental pollutants as well as possible theft while installed in a vehicle. First, the device achieves this by being able to be applied to all after market car stereos of DIN size, and giving the vehicle, which it is installed in, a factory look of having no stereo at all. This feature will discourage a thief from breaking into the car and stealing the after market car stereo. Second, the device protects the installed after market car stereo from various environmental pollutants by a filtration and insulation system.

### BRIEF DESCRIPTION OF DRAWINGS

FIG. 1 shows, from the right hand point of view, the front view of the device.

FIG. 2 shows, from the right hand point of view, the rear view of the device.

FIG. 2B shows the medium density foam located on the back of front panel.

FIG. 3 shows, from an upper left hand point of view, the rear view of the device.

FIG. 4 shows, from a lower right hand point of view, the rear view of the device.

FIG. 5 shows the top or bottom of the device from a point of view directly above or below the device.

FIG. 6 shows the side of the device, either the left or right, from a point of view directly to side of the device.

FIG. 7 shows a cross-section of FIG. 6.

FIG. 7B shows cross-section of foam referred to in FIG. 2B

FIG. 7C shows exploded portion of FIG. 7B.

### DETAILED DESCRIPTION

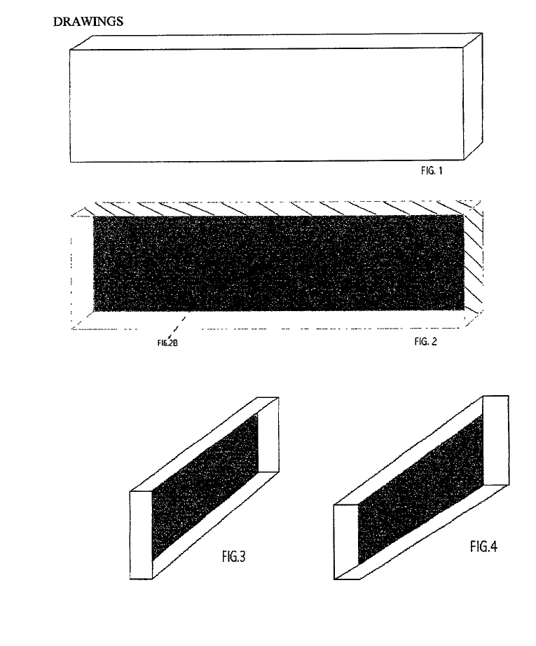

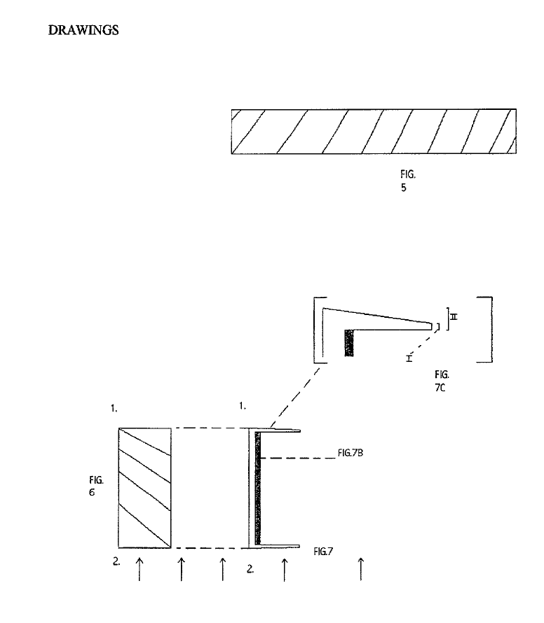

FIG. 1 shows the front of the device as one would see it protecting an after market car stereo from a right hand perspective. With the largest piece of the device being the back plate, and the other four pieces the sides. The device when applied, from this point of view, as well as any other, will give a vehicle having an after market car stereo the look of a car that had never had a stereo in it from the date of factory vehicle production. This is done by the device being constructed out of a multiple thickness plastic, which is what a car dash blank is constructed out of from a car manufacture when no car stereo is featured in the car. Thus, to a potential thief, there would appear to be no after market car stereo in the vehicle worth stealing. FIG. 2 shows the back of the device from an elevated point of view, or the side that is to face an after market car stereo upon application. FIG. 3 illustrates this same aft position, but from an upper left hand view. FIG. 4 illustrates this same aft position, but from a lower right hand point of view. All four sides of the device have a tapering feature to them, which allows the device to fit into vehicles whose stereos have minimal clearance between it and the dash of the car. The sides have a starting thickness of ⅛ inch and an ending thickness of 1/32 inch. The starting point is that of the back plate, and the ending point is that of the point furthest from the back plate. The inside width of the device will be 7 9/16 inches, and the height will be 2 5/16 inches. These measurements allow the device to fit onto after market car stereos equipped with a cosmetic trim ring, and those not but having the same dimensions as one with a cosmetic trim ring, by sliding it towards the dash and over the edges of the after market car stereo. The inside of the device has no supporting structure that protrudes out or into the device, which prior art does possess. The only material located in the inside cavity of the device, besides that of the plastic itself, is a medium density foam, which is illustrated in FIG. 2B. This medium density foam is applied to the inside of the back plate with an adhesive. The function of this medium density foam is to protect an after market car stereo from various environmental pollutants and conditions. It achieves this via filtration and insulation. A feature that is nonexistent in prior art. FIG. 5 is an illustration of the device from a point of view directly above or below the device. FIG. 6 is an illustration of the left or right side of the device from a direct side view. Both sides of FIG. 5 and FIG. 6 are constructed out of multiple thickness plastic. This tapering feature is detailed in the cross section of FIG. 6, which is FIG. 7. This figure shows both the tapering affect and the medium density foam (FIG. 7B) applied to the back plate. FIG. 7C shows an exploded view of a side, which shows the tapering feature in more detail. It details how the starting point, or that point of the side connected to the back plate, has a thickness of ⅛ inch by referring to it as II. It then details the ending point of the taper, or the point of the side furthest from the back plate, as having a thickness of 1/32 inch by referring to it as I. These two referrals in FIG. 7C show how all sides of the device will taper independent from the back plate. Both of the features illustrated here are not found with any prior art. The production of the device is done from a mold, which will form plastic into the described device, and give it its unique features and dimensions. After molded, the device will then have the medium density foam applied to the back plate via adhesive.

I claim:

1) This is a device for protecting aftermarket car stereos, both detachable and fixed panel, from various environmental pollutants, conditions and theft while installed in a vehicle.

2) The device is applied to a DIN size after market car stereo with a cosmetic trim ring, or DIN size after market car stereo without a cosmetic trim ring but with the same dimensions as one with a cosmetic trim ring, by sliding towards the dash and over the edges of the after market car stereo with the possession of the following components:
The device will have an inside width of 7 9/16 inch, and an inside height of 2 5/16 inches
This device is comprised of a back plate and four sides (two independently identical pairs) made out of multiple thickness plastic for universal application
The four sides will each taper from the point connected to the back plate at a thickness of an ⅛ inch, to the point furthest from the back plate at a thickness of 1/32 inch

3) A piece of medium density foam is attached to the inside of the back plate, which protects the after market car stereo, when applied, from environmental pollutants, by acting as a filter, and conditions, by acting as an insulator
